(19) United States
(12) Patent Application Publication
(10) Pub. No.: US 2007/0020368 A1
(43) Pub. Date: Jan. 25, 2007

(54) Low glycemic, high fiber composition of all natural compounds that provides a sweet flavor profile for use in foods, beverages or as a sugar substitute

(75) Inventors: Daniel A. Maiullo, Tinton Falls, NJ (US); Pete Maletto, Long Branch, NJ (US); Harvey W. Palat, Freehold, NJ (US)

Correspondence Address: DANIEL MAIULLO, 2970 Shafto Rd, Tinton Falls, NJ, 07753, US

(73) Assignee: SUGAR SENSE INC, New Jersey Corporation, FREEHOLD, NJ (US)

(21) Appl. No.: 11/188,012

(22) Filed: Jul. 25, 2005

(51) Int. Cl. A23L 1/236

(52) U.S. Cl. 426/548

(57) ABSTRACT

A composition of all natural compounds that provides a sweet flavor profile and is high in fiber and low glycemic for use in foods and/or beverages, and/or for use as a sugar substitute.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

There has been an increasing public awareness about the negative effects of consuming sugar, as well as the skyrocketing percentage of individuals who are diabetic in the United States and other countries as well. It has been estimated by the United States government that there are 18 million Americans that are currently diabetic. The public is realizing the dangers of excessive sugars in their diet. Many have switched to sugar free foods to avoid excess sugars, only to be exposed to chemical artificial sweeteners that are also undesirable. Most people are looking to reduce sugars because they are following some type of diet or weight loss regimen. The number of people following low sugar or sugar free diets is on the rise, and may include as much as one-third of the population or higher. This number varies seasonally and typically is higher, for example, after the holidays at the end of the year. Although many people reduce sugars to try to lose weight, many of these also want to avoid unhealthy artificial sweeteners and sugar alcohols.

The numbers of diabetics, pre diabetics and obese in America are on the rise, which is evident by the fact that America is generally regarded as the fattest country in the world due to Americans' indulgence in sugars and corn syrup found in most foods. A common practice among individuals trying to reduce their intake of sugars but still retain the sweet tastes to which they have grown accustomed is use artificial, low calorie or no calorie sweeteners. However, the common perception is that such artificial sweeteners may cause health problems. For this reason, there has been an emphasis on the development of natural sweeteners that might allow the individual to reduce the amount of sugar in his or her diet without sacrificing the esthetic aspects of foods or to risk health by using chemical sweeteners. As would be expected the primary emphasis in the development of an all natural sugar free sweetener/flavor is the esthetics, since it is generally recognized that sugar substitutes have little chance of survival in the marketplace if they do not have at least a tolerable taste. It will be appreciated that there is significant competition to create such products whose esthetic characteristics most closely resemble traditional sugar.

Artificial sweeteners, because of their universal functionality of reducing sugar content while retaining sweet tastes, has been the focus of numerous attempts to formulate “low carbohydrate”, “no sugar added”, or “sugar free” products. The predominant formulations developed in this effort have been artificial chemical formulations. It is generally agreed that there continues to be a need for an all natural, highly effective, sweetening agent as public awareness increases everyday about the negative health effects of artificial ingredients. The present invention provides a novel, all natural, low calorie, high fiber, sugar substitute that can be used in solid, semi-solid, and liquid food applications. The development of a sweeter and safer composition is intended to replace sugar, sugar alcohols, and artificial sweeteners with an all natural sweet-tasting product without significantly compromising the sensory qualities imparted by sugar.

### BRIEF SUMMARY OF THE INVENTION

This invention relates to a novel, all natural, low calorie, low glycemic, high fiber sweetening agent, consisting of maltodextrin fiber, oligofructose fiber, levulose, fructose, stevia rebaudiana, thaumatin, and neohesperidin dihydrochalcone. Together in this formulation these agents are approximately four times sweeter than sucrose (table sugar), while providing four kilocalories of energy (commonly expressed as calories) per gram as do other carbohydrates. The invention therefore provides only 25 percent of the calories, mostly from dietary fiber, as an equivalent amount of sweetness from sucrose.

### DETAILED DESCRIPTION OF THE INVENTION

In accordance with the present invention, there is provided an all natural low calorie, low glycemic formulation that is low in sugar content and high in fiber. The ingredients of the subject formulations are as follows.

The principal ingredient of the subject formulation is oligofructose. Oligofructose is the primary source of fiber therein. Oligofructose is a highly-functional form of fiber which is extracted from chicory. Its unique benefits include an increased prebiotic effect, selectively nourishing healthful (or ‘good’) colonic bacteria for an additional boost to digestive health and immune function. Of course, these benefits are in addition to other benefits of fiber consumption: moderation of glycemia, maintenance of good digestion, and weight-control properties. Oligofructose comprises from about 60% to about 70% by weight, preferably about 65% by weight, of the present formulation. The presence of oligofructose in the present invention is unique in having such a high content of fiber in comparison to no fiber present in conventional sugar, sugar alcohols, and artificial sweeteners. The presence of fiber in the present invention functions as a bulking agent and provides an added digestive health benefit to the consumer. A preferred oligofructose soluble powder product is Raftilose-GR which contains 80% to 95% fiber.

The second fiber component of the present invention is a soluble fiber of maltodextrin. This ingredient is a spray-dried powder produced by the pyrolysis and controlled enzymatic hydrolysis of cornstarch, is readily dispersible in water, and carries no inherent flavor. This soluble fiber ingredient, which is unique to this sweetening composition, contributes solids and texture to any finished product. A preferred maltodextrin soluble fiber product is Fibersol-2, available from Matsutani America, which contains from about 80% to 95% fiber. This material is present in the formulation from about 5% to about 15% by weight, preferably about 10% by weight.

The present invention contains a low glycemic sugar called levulose or fructose, which functions synergistically to increase the sweetness intensity of the other all natural sweeteners, thereby providing a sweeter characteristic which resembles other conventional nutritive and non-nutritive sweeteners. This sugar has a low glycemic index relative to sucrose. This fact should prove attractive to those with special diet considerations or who are diabetic. Levulose or fructose is present in the subject formulation in from about 18% to about 27% by weight, preferably about 23.9% by weight.

The present invention contains an enzymatically treated stevioside from the plant Stevia rebaudiana that is 200 times sweeter than sucrose. This stevioside is modified to significantly increase the sweetness content thereof. In general, Stevia rebaudiana will contain between 30% and 99% of the active glycosides, depending on the processing parameters and the manufacturer. It may be commercially available in various glycoside concentrations within this range. Preferably, the subject formulation contains stevioside having a glycoside content of about 90%. Stevioside is present in the subject formulations in from about 0.6% to about 1.4% by weight, preferably about 1% by weight. Stevioside provides intense sweetness while contributing no calories or sugar. This preferred flavoring ingredient is Sweta, produced by Stevian Biotechnology.

The present invention contains from about 0.02% to about 0.07% by weight, preferably about 0.03% by weight, of Thaumatin. Thaumatin is a mixture of intensely sweet proteins (thaumatins) extracted with water from the arils of the fruit of the West African perennial plant Thaumatococcus daniellii. It provides enhanced sweetness and flavor to the other ingredients in the preparation. As stated above, taste and flavor are very important criteria in the commercial acceptance of a low calorie sweetener product.

The present invention contains from about 0.03% to about 0.1% by weight, preferably 0.07% by weight, of neohesperidin dihydrochalcone. Neohesperidin dihydrochalcone (NHDC) is a non-carcinogenic natural citrus based sweetener product produced by a single hydrogenation step from neohesperidin, the main flavonoid present in bitter oranges. NHDC is 1500 times sweeter than sugar and is therefore used for a synergistic sweetness profile in the subject formulation. Synergistic ingredients like those stated above are used together to enhance the quality of the sweet profile in the product.

It has been found that the ingredients enumerated above complement each other in developing a sweet flavor formulation that is comparable in taste to conventional nutritive and non-nutritive sweeteners. This is considered surprising in that a number of these ingredients are not found in any other formulations. It is also not conventional to prepare sweeteners with the health benefits of dietary fiber. The present invention may be utilized in all varieties of solid and semi-solid food preparations, beverages and frozen confections where sugar would normally be utilized.

The present invention can be formulated into any food desired where sugar would normally be used in accordance with traditional recipes but at a 75% reduction in usage as compared to sugar. It produces similar browning functionality to sugar while baking. It also provides solids content in the overall product.

The following examples further illustrate the current invention, but are not in any way intended as being limiting thereon:

### EXAMPLE 1

The following formulation was utilized to prepare the low calorie sugar substitute bulk powder:

Ingredient Quantity in Grams: Oligofructose 650.0 (Raftilose, Orafti), Maltodextrin Fiber 100.0 (Fibersol 2, Matsutani America), Levulose or Fructose 239.0, Stevioside 10.0, Thaumatin 0.3, Neohesperidin Dihydrochalcone 0.7, Total 1,000.

The dry ingredients consisting of the oligofructose and maltodextrin dietary fiber, stevioside, levulose or fructose, thaumatin, and neohesperidin are then combined in a suitable mixing vessel and mixed until thoroughly blended.

The present invention provides a number of advantages, such as the following:

1. Oligofructose and maltodextrin fiber act as soluble fiber bulking agent in the invention. Like all dietary fibers, they are not digested in the stomach or small intestine. However, because they are completely fermented in the colon, they contribute to better gut function, improve regularity and reduce constipation in humans and other mammals. Oligofructose is selectively fermented by Bifidobacteria and boosts the total number of these micro-organisms present in the colon. Bifidobacteria are known to have a number of beneficial effects on human health.

2. The all natural ingredients of the present invention have no history of side effects, are non-carcinogenic and non-toxic.

3. The present invention permits direct sugar replacement in a easy to use 4:1 ratio. So in recipes that would normally use 1 cup of sugar, the present invention would use just ¼ cup, but provide the same sweetness profile as the original recipe using conventional sugar. This is an important advantage, especially in home consumer applications.

4. Like all dietary fibers, oligofructose and maltodextrin fiber have no impact on blood sugar. These fibers in the subject formulation also have the ability to slow down the glycemic index of any food eaten, which makes it suitable for special diets where glycemic control is necessary, such as diabetes.

5. Unlike many artificial sweeteners, the present invention of all natural ingredients possesses thermostability for a wide range of food applications.

6. The present invention is approximately four times sweeter than table sugar (sucrose), allowing it to be used at one-fourth the level of table sugar to achieve a similar sweetness. It therefore contributes only one-fourth the calories of table sugar, aiding in weight loss, low sugar, low carbohydrate, low glycemic, and low calorie diets.

What is claimed is:

1. A composition of all natural compounds that provide a sweet flavor profile comprising any three or more of the following: a) all natural sweet glycosides, including those derived from the plant stevia rebaudiana and those derived from other sources; b) all natural sweet proteins, including thaumatins derived from the plant Thaumatococcus daniellii and other sweet proteins derived from other sources; c) all natural sweet bioflavonoid compounds, including neohesperidin dihydrochalcone derived from bitter oranges and others; d) all natural fiber bulking agents, including those derived from oligofructose, maltodextrin fiber, and others; and e) all natural sugar, including levulose and others.

2. A composition according to claim 1, for use in solid, semi-solid, and/or liquid foods.

3. A composition according to claim 1, for use as a sugar substitute.

4. A composition according to claim 1, comprising: a) all natural sweet glycosides, including those derived from the plant stevia rebaudiana and those derived from other sources; b) all natural sweet proteins, including thaumatins derived from the plant Thaumatococcus daniellii and other sweet proteins derived from other sources; c) all natural sweet bioflavonoid compounds, including neohesperidin dihydrochalcone derived from bitter oranges and others; d) all natural fiber bulking agents, including those derived from oligofructose, maltodextrin fiber, and others; and e) all natural sugar, including levulose and others.

5. A composition according to claim 4, for use in solid, semi-solid, and/or liquid foods.

6. A composition according to claim 4, for use as a sugar substitute.

7. A composition according to claim 1, comprising: a) all natural sweet glycosides derived from the plant stevia rebaudiana in the amount of approximately 0.6 percent to 1.4 percent of the total composition by weight; b) all natural thaumatins derived from the plant Thaumatococcus daniellii in the amount of approximately 0.02 percent to 0.07 percent of the total composition by weight; c) all natural sweet bioflavonoid neohesperidin dihydrochalcone derived from bitter oranges in the amount of approximately 0.03 percent to 0.1 percent of the total composition by weight; d) all natural fiber bulking agents derived from oligofructose in the amount of approximately 60 percent to 70 percent of the total composition by weight; e) all natural fiber bulking agents derived from maltodextrin fiber in the amount of approximately 5 percent to 15 percent of the total composition by weight; and f) all natural sugar levulose or fructose in the amount of approximately 18 percent to 27 percent of the total composition by weight.

8. A composition according to claim 7, for use in solid, semi-solid, and/or liquid foods.

9. A composition according to claim 7, for use as a sugar substitute.
